(19) United States
(12) Patent Application Publication
(10) Pub. No.: US 2022/0341902 A1
(43) Pub. Date: Oct. 27, 2022

(54) Metal Oxides Enabled Fiber Optic pH Sensor for High temperature High pH Subsurface Environments

(71) Applicant: United States Department of Energy, Washington, DC (US)

(72) Inventors: Fei Lu, Lubbock, TX (US); Ruishu Feng Wright, Pittsburgh (US); Paul R. Ohodnicki, JR., Allison Park, PA (US); Ping Lu, West Hartford, CT (US)

(21) Appl. No.: 17/729,511

(22) Filed: Apr. 26, 2022

Related U.S. Application Data
(60) Provisional application No. 63/180,214, filed on Apr. 27, 2021.

(51) Int. Cl. G01N 31/22; G01N 21/80; C01B 33/12; C01G 23/047; C01G 25/02; C01G 35/00; C01F 7/02; G01L 11/02

(52) U.S. Cl. CPC G01N 31/22; G01N 21/80; C01B 33/12; C01G 23/047; C01G 25/02; C01G 35/00; C01F 7/02; G01L 11/025

(57) ABSTRACT

A system for determining pH of a fluid and a method to determine the pH of a fluid contacting a sensor, the method having the steps of: providing the sensor to an environment such that the sensor is in contact with the fluid, wherein the sensor features a fiber extending between a first end and a second end along a longitudinal axis, wherein the fiber further features a medial portion positioned between the first and second ends, wherein the sensor further features a pH sensitive coating on the medial portion of the fiber, and wherein the pH sensitive material features a metal oxide including but not limited to SiO₂, TiO₂, ZrO₂, Ta₂O₅, A₂O₃, and combinations thereof; interrogating the sensor with an optical signal; collecting a modified optical signal after the sensor has been interrogated; and determining the pH of the fluid contacting the pH sensor using the modified optical signal.

### CROSS-REFERENCE TO RELATED APPLICATIONS

This Utility Patent Application claims priority benefit as a U.S. Non-Provisional of U.S. Provisional Patent Application Ser. No. 63/180,214, filed on Apr. 27, 2021, currently pending, the entirety of which is incorporated by reference herein.

### STATEMENT OF GOVERNMENT SUPPORT

The United States Government has rights in this invention pursuant to the employer-employee relationship of the Government to the inventors as U.S. Department of Energy employees and site-support contractors at the National Energy Technology Laboratory.

### FIELD OF THE INVENTION

Embodiments relate to pH sensors comprising optical fibers coated with metal oxide, wherein said sensors are suitable for use in high temperature and pressure environments such as wellbores and high pH conditions in cement. Several embodiments of the invented pH sensors have demonstrated suitability for continuously monitoring pH conditions of high pressure and high temperature, subsurface environments.

### BACKGROUND

Monitoring of the chemical composition in subsurface environments including downhole and underwater conditions is crucial for various fossil energy related applications including deep and ultra-deep oil and gas resource recovery through drilling and hydraulic fracturing techniques as well as environmental monitoring in reservoirs for CO₂ sequestration, natural gas storage, and hydrogen storage. Subsurface environments are extremely challenging for the development and deployment of sensing technologies because of the harsh conditions that exist including high temperature, high pressure, corrosive chemical species, and potentially high salinity. Table 1 presents the downhole environments in exemplary oil and gas reservoirs in the United States. Table 1 clearly demonstrates that the relevant downhole sensing conditions have temperatures ranging up to 300 ° C. and pressures ranging up to 30,000 psi. In such harsh environments, most electrical and electronic components used in sensor applications are not feasible because of the instability of packaging, wires, and interconnects. Therefore, it is essential to develop approaches that could eliminate the use of electrical components and connections at the sensing locations, as well as to avoid the common modes of failures in conventional sensors.

TABLE 1
Overview of Downhole Environments Relevant for Unconventional, Deep, and
Ultradeep Resource Recovery

| | | | Eagle | | | | Deep/Ultra |
|---|---|---|---|---|---|---|---|
| | Bakken | Barnett | Ford | Fayetteville | Haynesville | Marcellus | deep |
| Stratigraphic | Late | Mississippian | Cretaceous | Mississippian | Upper | Middle | Various |
| Range | Devonian | | | | Jurassic | Devonian | |
| | to | | | | | | |
| | Upper | | | | | | |
| | Mississippian | | | | | | |
| Drilling | 4,500- | 6,500- | 4,000- | 1,500- | 10,500- | 5,000- | 30,000- |
| Range | 7,500 | 8,500 | 14,000 | 6,500 | 13,500 | 10,000 | 40,000 |
| (feet) | | | | | | | |
| Technically | Oil: 3.6 | Gas: 43 | Gas: 40 | Gas: 32 | Gas: 75 | Gas: 410 | Gas: 85.88 |
| Recoverable | | | Oil: 2.9 | | | | Oil: 419.88 |
| Gas | | | | | | | |
| (TCF) | | | | | | | |
| and/or Oil | | | | | | | |
| (BbbL) | | | | | | | |
| Temp (F°) | Up to 200 | Up to 200 | Up to 340 | Up to 180 | Up to 380 | Up to 180 | Up to 572 |
| | Bakken | Barnett | Eagle | Fayetteville | Haynesville | Marcellus | Deep/Ultra |
| | | | Ford | | | | deep |
| Pressure | 5,500- | 3,000- | | | Over | | Up to |
| (psi) | 5,800 | 4,000 | | | 10,000 | | 30,000 |

| Potential | Flow, T, P, pH, gas composition, gas saturation |
|---|---|
| Monitoring | |
| Parameters | |

| | |
|---|---|
| Chemicals | HCl, CaCl, KCl, ZnBr, NaCl, Fe²⁺,Fe³⁺, Sulfates, H₂S, CO₂, CH₄, H₂ with many |
| of Interest | of the chemicals in solutions at a wide range of pH, with higher pH levels |
| in | relevant for embedding sensors within wellbore cement. |
| Subsurface | |

Compared to traditional sensing methods, fiber-optic pH sensors offer desirable advantages. They are chemically and thermally stable, light-weight, and small-sized. Fiber optic sensors can feature configurations avoiding use of traditional electrical components and wiring, providing immunity to electromagnetic interference. In addition, fiber optic sensors do not need a separate reference electrode as needed in potentiometric sensing methods which faces stability issues at high temperature applications. More importantly, fiber optic sensors have promising potential for remote, distributed, and continuous pH sensing in harsh environments.

Fiber optic sensors have been deployed for distributed temperature and pressure sensing in the subsurface, for example, utilizing fiber-Bragg gratings on the optical fiber or backscattering interrogation. However, fiber optic sensors, such as pH sensors, have not yet been commercially available due to the lack of useful, reversible, and robust sensing materials in demanding conditions in the subsurface. The invention described here directly addresses this need by demonstrating a group of sensing materials, metal oxides (MeOx), that present a good optical response to pH with reversibility and repeatability in the conditions of elevated temperature and pressure which are suitable for deployment in subsurface environments.

pH is a crucial parameter to measure in many applications such as environmental science, civil engineering, biotechnology, clinical chemistry, biomedical diagnosis, earth science, and marine science. Accurate measurement of pH in subsurface wellbores is critical for early corrosion detection and wellbore cement failure prediction.

At the early stage of the wellbore cement, pH of the cement pore liquid is around 13 after setting. The pH value can be reduced by cement carbonation, sulfate attack, and acid attack in the CO₂/H₂S containing environment in the wellbore, resulting in high risks of wellbore integrity failures as wellbore cement becomes less stable and more permeable below pH 10.5. Lower pH also makes the casing steel more susceptible to corrosion due to increased acid attack and eventually causes wellbore integrity failures to occur. pH of the subsurface fluid can be measured from downhole samples when they are transported to laboratories above the ground. However, the gases and solids from these downhole samples are often removed before the pH can be measured, such samples providing an inaccurate characterization of the real situation in the subsurface. Therefore, subsurface sensing technology is of interest for real-time monitoring of pH in native conditions in the location of interest at reservoir temperatures and pressures.

A range of technologies for pH sensing exist for aqueous conditions including traditional potentiometric pH electrodes, pH sensitive dyes, and emerging pH sensors (e.g. surface acoustic wave (SAW) devices). All fall short of distributed pH sensing capacity distinctly available for optical fiber sensors.

In addition, each method has weaknesses for the application of interest. Standard pH measurements are performed conventionally by potentiometric electrodes, but they are fragile, prone to drifting, and suffer from alkali errors. The measurements cannot be employed at high temperatures and pressures. Solid-state electrodes have also been developed that could work at the demanding harsh environment. However, it is difficult to find suitable reference electrodes in such conditions and proper referencing also requires the information of the solution ion activities, which is also a challenge.

Traditionally, pH indicators are organic dyes which indicate the pH by determination of color, but their sensitive range as well as temperature stability are limited. pH indicators are susceptible to imprecise readings merely by color change. To increase the precision of the reading, they have been incorporated into polymer or inorganic oxides and integrated with optic fibers for more accurate optical measurements. However, such configuration often encounters leaching or photo bleaching over time resulting in long-term drifting during measurement.

In SAW devices, pH change causes a conductivity change of a sensitive layer in a sensitive region, which can be monitored by the surface acoustic signals. SAW devices are claimed to be low cost and to have good mechanical properties. However, only the shear horizontal (SH) waves are promising for use in liquids. Utilization of SH wave requires excellent quality of the device since it is easily affected by the acoustoelectric interaction between the electric field and the electric properties of the materials in the adjacent liquid. No SAW pH sensors at elevated temperature have been investigated. Similar to fiber optic pH sensors, SAW pH sensing devices do not need a reference electrode. But, distributed sensing is not possible using SAW devices.

Polymers such as polyaniline have also been utilized as the pH sensing layer on optical fiber based on the optical property responses to the varying pH due to the protonation/deprotonation of the polymer network. Layer by layer (LbL) coatings of different polymers for pH sensing have been investigated, for example, poly(allylamine hydrochloride)/Poly(acrylic acid) (PAH/PAA) or poly(diallyldimethylammonium)/Poly(acrylic acid) (PDDA/PAA). However, such films can suffer from instabilities upon exposure to air and are reported to exhibit significant hysteresis upon cycling of pH values. In addition, few polymers have the glass transition temperature higher than 150° C., which limits their application in the high-temperature subsurface conditions.

Furthermore, several technologies utilize phosphor materials and employ pH dependent fluorescence to monitor pH. However, such approaches require expensive optical instrumentation. As such, in most cases, fiber optic pH sensors based on light absorption are preferred because of the simplicity and cost-effective nature of such sensors.

It would be advantageous if a technique allows for mapping of information about pH in real-time spatially within wellbores and throughout geological formations. It would also be beneficial if the sensing approach was optical-based in nature with a sensing response that avoids using an organic indicator dye or polymer due to inherent limitations in both temperature stability and resistance to leaching. Higher stability matrices and substrates are desired for long-term operation in harsh subsurface environments, and it would also be advantageous for a technique to have true distributed sensing which may only be provided by optical fiber sensors. As such, it would be preferred to have an optical fiber sensor functionalized with pH sensing materials that exhibit excellent chemical and temperature stability and demonstrate a reversible response to changing pH conditions.

The invention demonstrated here addresses these advantages by exploiting optical property changes of a sensing layer that is stable under down-hole conditions. The sensing layer comprises metal-oxide-based thin films which exhibit a strong overall optical response associated with reversible interactions between the sensing material and the solution for which pH is being monitored. A key distinguishing feature of the invention described is that metal-oxide-based films are inherently stable in harsh environments. Exploitation of different kinds of metal oxide based films as the light absorption-based indicator elements to replace organic dyes potentially allows for a broader application range, improved temperature stability, and the possibility of multi-parameter monitoring through broadband wavelength interrogation by monitoring changes in optical properties in response to other important parameters such as temperature, pressure, and other chemical species present in the solution phase such as salinity, ionic strength, etc. Multi-parameter monitoring for purposes of self-compensation to reduce or eliminate cross-correlations between pH and other parameters (e.g. temperature) may also be possible.

A need in the art exists for a pH sensor suitable for deployment in harsh environments that overcomes the disadvantages of the prior art.

### SUMMARY

One object of the invention is providing a pH sensor suitable for measuring the pH of subsurface environments, especially the high temperature high pH conditions in wellbore cement. The invented sensor comprises an optical fiber coated with a pH sensitive material comprising a metal oxide or a plurality of metal oxides. Said sensor is suitable for deployment in subsurface environments such as wellbore cement along with a suite of other technologies to enable continuous monitoring of subsurface conditions.

The invented pH sensors have demonstrated superior suitability for continuous and in-situ use in subsurface environments to monitor pH conditions.

The invention provides a method to determine the pH of a fluid contacting a sensor comprising: providing the sensor to an environment such that the sensor is in contact with the fluid, wherein the sensor comprises a fiber extending between a first end and a second end along a longitudinal axis, wherein the fiber further comprises a medial portion positioned between the first and second ends, wherein the sensor further comprises a pH sensitive coating on the medial portion of the fiber, and wherein the pH sensitive material comprises a metal oxide; interrogating the sensor with an optical signal; collecting a modified optical signal after the sensor has been interrogated; and determining the pH of the fluid contacting the pH sensor using the modified optical signal.

The invention also provides a pH sensor comprising: a fiber extending between a first end and a second end along a longitudinal axis, wherein the fiber further comprises a medial portion positioned between the first and second ends; a pH sensitive coating on the medial portion of the fiber, wherein the pH sensitive material comprises a metal oxide.

### BRIEF DESCRIPTION OF THE DRAWINGS

The invention together with the above and other objects and advantages will be best understood from the following detailed description of the preferred embodiment of the invention shown in the accompanying drawings, wherein:

FIG. 1A is a simplified schematic of a system for measuring the pH of a fluid using a fiber optic sensor featuring a pH sensitive coating, in accordance with the features of the present invention;

FIG. 1B is a detail view of a fiber optic pH sensor featuring a pH sensitive coating, in accordance with the features of the present invention;

FIG. 1C is a cross sectional view of a fiber optic pH sensor featuring a pH sensitive coating, in accordance with the features of the present invention;

FIG. 2A is a simplified schematic of a distributed system for measuring the pH of a fluid using a fiber optic sensor featuring a pH sensitive coating, in accordance with the features of the present invention;

FIG. 2B is a detail view of a fiber optic pH sensor featuring a pH sensitive coating for distributed pH sensing, in accordance with the features of the present invention;

FIG. 3 is a cross sectional view of a fiber optic pH sensor featuring a pH sensitive coating and a porous underlayer, in accordance with the features of the present invention;

FIG. 4 is a cross sectional view of a fiber optic pH sensor featuring a pH sensitive coating and a protective overcoat, in accordance with the features of the present invention;

FIG. 5 is a flow chart for a method of measuring the pH of a fluid using a fiber optic pH sensor featuring a pH sensitive coating, in accordance with the features of the present invention;

FIG. 6A is a cross-sectional SEM image of TiO₂ deposited on a coreless fiber using sol-gel coating, in accordance with the features of the present invention;

FIG. 6B is a cross-sectional SEM image of ZrO₂ deposited on a coreless fiber using sol-gel coating, in accordance with the features of the present invention;

FIG. 7A is a cross-sectional SEM image of TiO₂ deposited on a coreless fiber using ALD, in accordance with the features of the present invention;

FIG. 7B is a zoomed in cross-sectional SEM image of TiO₂ deposited on a coreless fiber using ALD, in accordance with the features of the present invention;

FIG. 8A is transmission spectra of a sol-gel TiO₂ coated fiber while being exposed to solutions with different pH values at room temperature, in accordance with the features of the present invention;

FIG. 8B is transmission of a sol-gel TiO₂ coated fiber at 600 nm wavelength as a function of time while being exposed to solutions with different pH values at room temperature, in accordance with the features of the present invention;

FIG. 9A is transmission of a sol-gel TiO₂ coated fiber at 600 nm wavelength as a function of time while being exposed to solutions with different pH values at 80° C., in accordance with the features of the present invention;

FIG. 9B is transmission of a sol-gel ZrO₂ coated fiber at 535 nm wavelength as a function of time while being exposed to solutions with different pH values at 80° C., in accordance with the features of the present invention;

FIG. 10A is transmission spectra of an Au—TiO₂ coated fiber while being exposed to solutions with different pH values at 80° C., in accordance with the features of the present invention;

FIG. 10B is transmission of the Au—TiO₂ coated fiber at 410 nm wavelength as a function of time while being exposed to solutions with different pH values at 80° C., in accordance with the features of the present invention;

FIG. 11 is transmission of a TiO₂ coated fiber with PSU overcoat at 550 nm wavelength as a function of time while being exposed to solutions with different pH values at 80° C., in accordance with the features of the present invention;

FIG. 12A is transmission spectra of a fiber coated with TiO₂ using ALD while being exposed to solutions with different pH values at room temperature, in accordance with the features of the present invention;

FIG. 12B is transmission of a fiber coated with TiO₂ using ALD at 600 nm wavelength as a function of time while being exposed to solutions with different pH values at room temperature, in accordance with the features of the present invention;

FIG. 13A is transmission of a fiber coated with TiO₂ using ALD at 600 nm wavelength over time while being exposed to solutions with different pH values at 80° C., in accordance with the features of the present invention;

FIG. 13B is transmission of a fiber coated with TiO₂ using ALD at 600 nm wavelength over time at 80° C. while being exposed to DI water and a solution having a pH value of 12, in accordance with the features of the present invention;

FIG. 13C is transmission spectra of a fiber coated with TiO₂ using ALD while being exposed to solutions with different pH values at 80° C., in accordance with the features of the present invention;

FIG. 14A is OBR traces of a fiber coated with SiO₂ at three sections (A, B, and C) while being contacted with solutions with different pH values at room temperature, in accordance with the features of the present invention; and

FIG. 14B is the correlation curves between the derived intensity of the backscattered light and pH values in SiO₂ coated regions (Sections A, B and C) and in the bare uncoated coreless fiber region (Section X), in accordance with the features of the present invention;

FIG. 15A is OBR traces of a fiber coated with Au—SiO₂ at two sections while being contacted with solutions with different pH values at room temperature, in accordance with the features of the present invention; and

FIG. 15B is the correlation curves between the derived intensity of the backscattered light and pH values in Au—SiO₂ coated regions (Sections A and B) and in the bare uncoated coreless fiber region (Section X), in accordance with the features of the present invention.

### DETAILED DESCRIPTION

The foregoing summary, as well as the following detailed description of certain embodiments of the present invention, will be better understood when read in conjunction with the appended drawings.

The following detailed description should be read with reference to the drawings in which similar elements in different drawings are numbered the same. The drawings, which are not necessarily to scale, depict illustrative embodiments and are not intended to limit the scope of the invention.

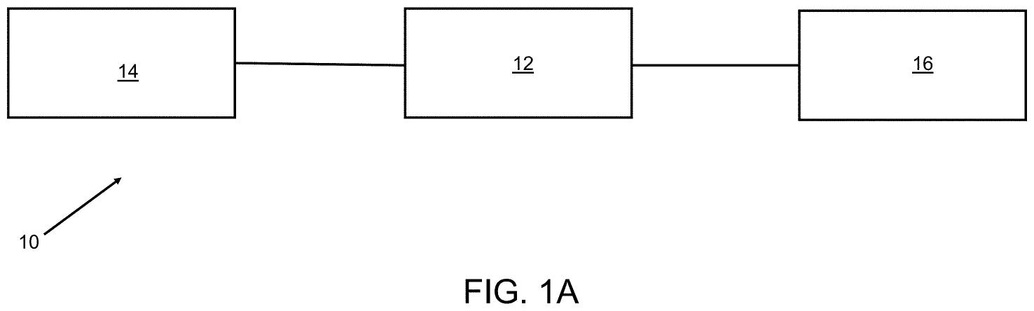

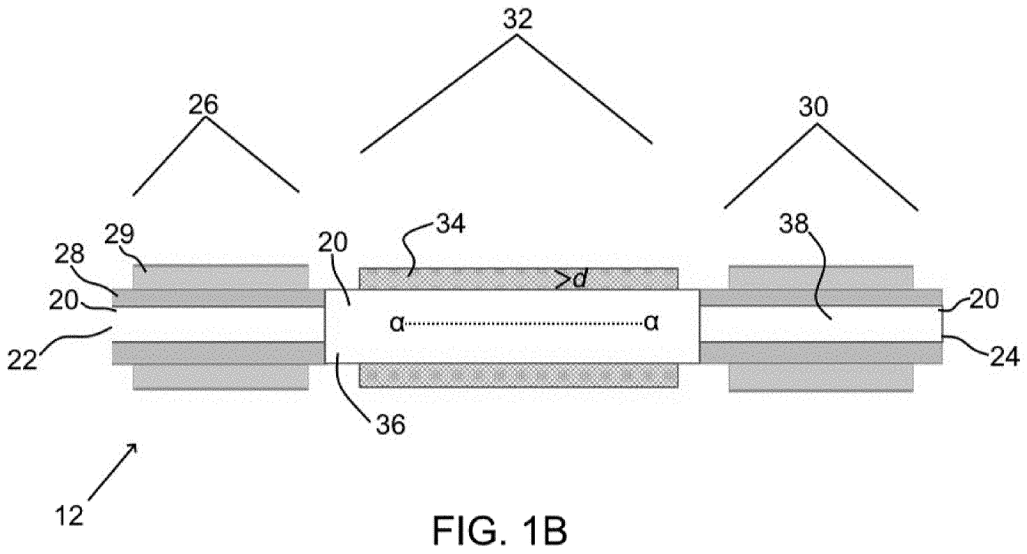

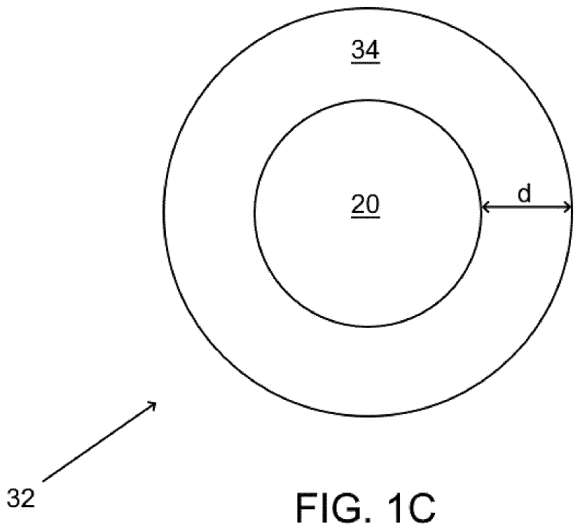

FIG. 1A depicts a simplified schematic of a sensor system 10 for measuring pH of a surrounding environment using the invented pH sensor 12. As shown in FIG. 1A, the system 10 comprises a light source 14 upstream from and in optical communication with the pH sensor 12. The pH sensor 12 is upstream from and in optical communication with a detector 16.

In an embodiment, the light source 14 is any device suitable for sending an optical signal to the pH sensor 12. Exemplary light sources include broadband lamp light sources and light-emitting diodes (LEDs).

In an embodiment, the detector 16 comprises any device suitable for receiving and measuring an optical signal. For example, an embodiment uses a spectrometer to measure light absorbed or transmitted from the pH sensor 12.

Exemplary detectors include broadband spectrometers and photodiodes. In the system 10 shown in FIG. 1A, the detector 16 is a simple optical detector that measures light it receives from the fiber after said light has gone through the pH sensor 12.

FIG. 1B is a simplified schematic of the invented pH sensor 12. As shown in FIG. 1B, the sensor 12 comprises an optical fiber 20 extending between a first 22 and second end 24 along the longitudinal axis α of the fiber. A proximal portion 26 of the fiber 20 adjacent to and including the first end 22 is overlaid and surrounded by a cladding 28, wherein the cladding 28 is optionally overlaid and surrounded by a polymer jacket 29. A distal portion 30 of the fiber 20 adjacent to and including the second end 24 is also optionally overlaid and surrounded by the cladding 28, wherein the cladding 28 can optionally be overlaid and surrounded by a polymer jacket 29. A medial portion 32 of the fiber 20 positioned between the proximal 26 and distal portions 30 of the fiber does not feature cladding or a polymer jacket. The medial portion 32 of the fiber 20 is coated with a pH sensitive material 34.

The above describes the pH sensors 12 featuring proximal 26, medial 32, and distal portions 30. This is exemplary and not meant to be limiting. Practical embodiments can comprise a plurality of portions of fiber overlaid by pH sensitive material 34 positioned between portions of the fiber overlaid by cladding 28. Embodiments can also comprise an end-coated segment of fiber overlaid by pH sensitive material 34, wherein the reflection of light from said end-coated segment is measured. In such an embodiment, the light source 14 and detector 16 are on the same side of the sensor 12.

In an embodiment of the sensor 12, the medial portion 32 of fiber 20 that is overlaid by pH sensitive material 34 is coreless fiber 36. In these embodiments, the coreless fiber 36 is positioned between and fused or coupled to segments of cladded fibers, wherein the fibers in the clad segments are multi-mode fiber 38.

A salient feature of the invention is the pH sensitive material 34 used as an overlayment (coating) on portions of a fiber, or as an overlayment on the end of a segment of a fiber. The pH sensitive material 34 comprises any material that exhibits a measurable variation to an optical constant in response to variation in the pH of a fluid contacting said pH sensitive material 34. Suitable materials include metal oxides having the general formula MeOx that are stable in harsh environments, i.e. high temperatures, high pressures, and high pH. Exemplary pH sensitive materials include SiO₂, TiO₂, ZrO₂, Ta₂O₅, Al₂O₃, and combinations thereof. In an embodiment, the pH sensitive material 34 combines one or more of these metal oxides with plasmonic Au-nanoparticles (NP).

In an embodiment, the pH sensitive material 34 is applied to an underlying fiber 20 using any suitable procedure for providing a thin coating of the MeOx material onto the fiber. Exemplary procedures include sol-gel coating, atomic layer deposition, dip coating, sputtering deposition, and combinations thereof.

FIG. 1C is a cross-sectional view of a medial segment 32 of fiber 20 with a coating of the pH sensitive material 34. As shown in FIG. 1C, the coating of pH sensitive material 34 has a thickness d. A person having ordinary skill in the art can readily discern that a coating of any thickness can be generated using one of the coating procedures described above. In an embodiment, the coating of pH sensitive material 34 has a thickness d between approximately 10 nm and approximately 1 μm.

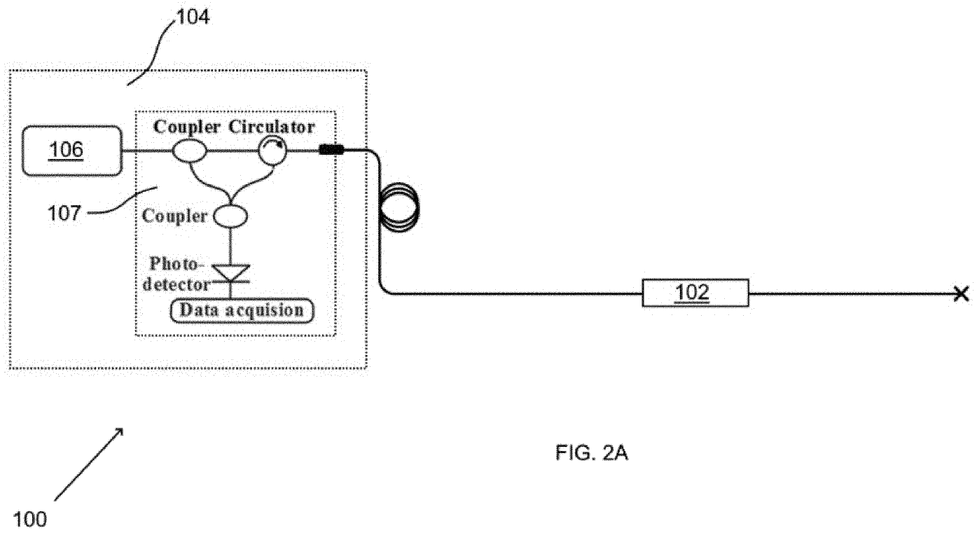

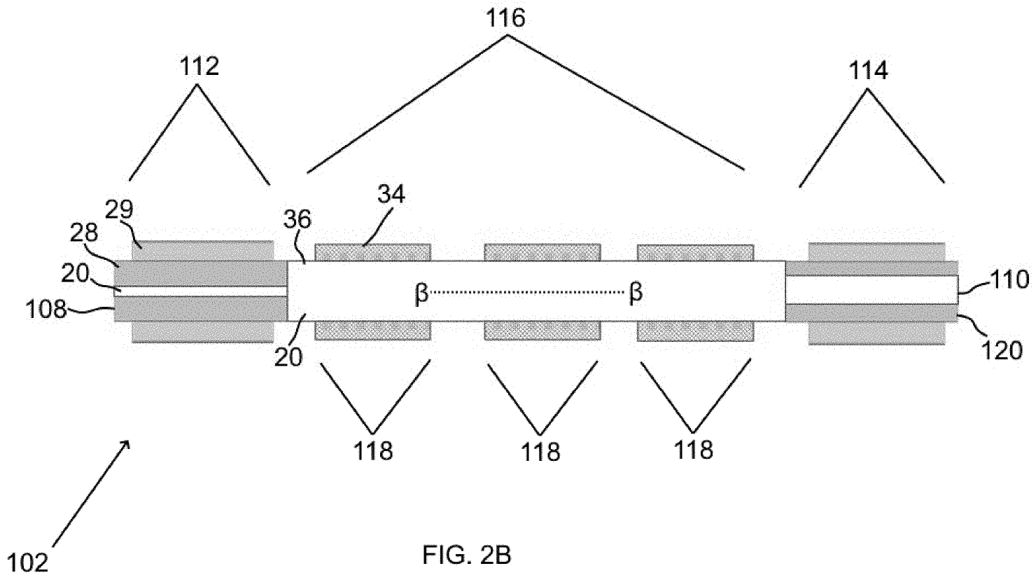

FIG. 2A is a simplified schematic of a system 100 for distributed measurement of pH of a surrounding environment using the invented pH sensor 102. As shown in FIG. 2A, the system 100 comprises an optical backscatter reflectometry (OBR) interrogator 104 upstream from and in optical communication with the pH sensor 102. The OBR interrogator 104 comprises a tunable laser 106 and a combined optical signal distributing and processing assembly 107. This embodiment uses optical backscatter reflectometry (OBR) to measure light scattered back upstream from the pH sensor 102. The operating principle of the OBR interrogator 104 allows for measurements of spatial profiles of backscattered light over the length of optical fiber. In the configuration depicted in FIG. 2A, the OBR interrogator 104 contains a light source, components that distribute an optical signal to the pH sensor 102, and the detector that collects and analyzes light backscattered from said sensor 102.

A salient feature of the embodiment depicted in FIGS. 2A-2B is the ability to continuously provide real-time, in-situ, and spatially distributed pH values for fluids contacting the sensor 102 with location information. Using the sensor 102 with a plurality of discrete portions coated with pH sensitive material 34 and the OBR interrogator 104, a user can determine the pH of fluid contacting the sensor at each of the various and discrete points along the length of the sensor that feature pH sensitive material 34.

FIG. 2B is a simplified schematic of the invented pH sensor 102. As shown in FIG. 2B, the sensor 102 comprises an optical fiber 20 extending between a first 108 and second end 110 along the longitudinal axis β of the fiber. A proximal portion 112 of the fiber 20 adjacent to and including the first end 108 is overlaid and surrounded by a cladding 28, wherein the cladding 28 can optionally be overlaid and surrounded by a polymer jacket 29. A distal portion 114 of the fiber 20 adjacent to and including the second end 110 is also overlaid and surrounded by the cladding 28, wherein the cladding 28 can optionally be overlaid and surrounded by a polymer jacket 29. A medial portion 116 of the fiber 20 positioned between the proximal 112 and distal portions 114 of the fiber is not overlaid by the cladding 28. The medial portion 116 of the fiber 20, comprises a plurality of lengths of fiber 118 that are coated by pH sensitive material 34.

In an embodiment of the sensor 102, the medial portion 116 of fiber 20 extending through segments that are overlaid by pH sensitive material 34 is a coreless fiber 36. In these embodiments, coreless segments are positioned between and fused or coupled to segments of cladded fibers, wherein the fiber in the clad segments are multi-mode fiber or single-mode. In the embodiment depicted in FIG. 2B, the first end 108 of the fiber comprises single-mode fiber and the second end 110 of the fiber comprises multi-mode fiber. In this embodiment, the second end 110 of the fiber comprising multi-mode fiber is the terminating end 120.

Various embodiments of the invention use a sensor 12 or sensor 102 featuring a fiber coated in a metal oxide (MeOx) that is optically sensitive to the pH of a surrounding fluid. One distinguishing feature of the invention is the simplicity of utilization of metal oxides to coat on optical fibers, which is beneficial for mass production. Another salient feature of the invention is that the optical response is broadband. Therefore, a light power meter or other low-cost optical interrogator designs could also be used for pH monitoring thus further reducing the deployment and operation cost. Alternatively, when connected to an optical backscattered light interrogator, the pH spatial profile of the fluid surrounding the invented sensor can be measured in real time along the optical fiber for distributed pH sensing. A scanning electron microscope (SEM) was used to confirm the successful coating of MeOx. In addition, the pH sensitive MeOx may be incorporated with other porous pH inert material to achieve ruggedized packaging.

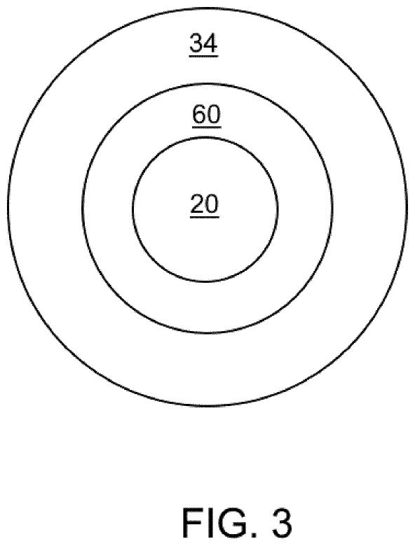

FIG. 3 shows an optional feature of the invented pH sensor where areas of the fiber 20 that feature the pH sensitive material 34 comprise an undercoat of porous inorganic oxide 60. As shown in FIG. 3, this embodiment features a porous inorganic oxide layer 60 coated onto the fiber 20, with a coating of pH sensitive material 34 applied to the inorganic oxide layer 60. The inorganic oxide layer comprises SiO₂, TiO₂, Al₂O₃, ZrO₂, as well as other inorganic oxides and combinations thereof. In this embodiment, the porous inorganic oxide underlayer 60, allows for tailoring the refractive index of the layer of pH sensitive material to a desired value by tuning the porosity. This can optimize the refractive index to be lower than that of the silica fiber core to maintain effective light propagating within the core while still permitting a desired degree of interaction between the sensing layer and the propagating light in the evanescent field to enable an optimized sensing response. In this embodiment, an overcoat of pH sensitive material 34 which typically displays a higher refractive index than the silica fiber core, when coated over the porous inorganic oxide layer 60, can then be applied to both stabilize the underlying porous inorganic oxide layer 60 and fiber 20, as well as to provide an optimized and stable pH response under basic conditions at high operational temperatures. An additional benefit of a porous inorganic oxide underlayer is the potential to maximize the surface area of interaction between the pH sensing layer and the solution having a pH to be measured, which can further enhance sensitivity.

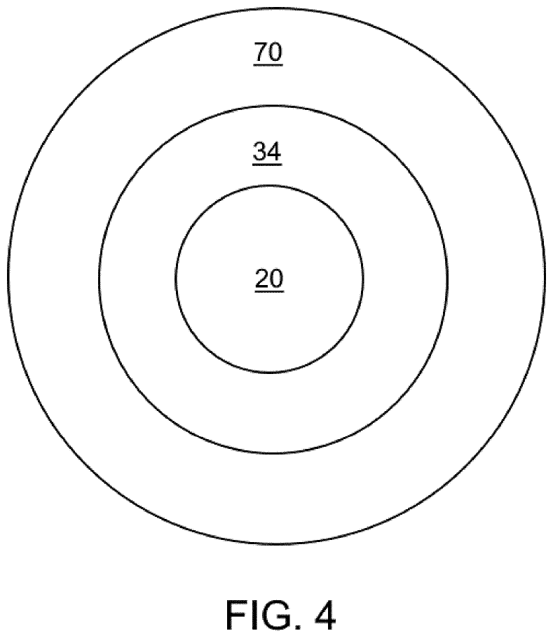

FIG. 4 shows another optional feature of the invented pH sensor where areas of the fiber 20 that are overlaid with pH sensitive material 34 further comprise a protective overcoat 70. The overcoat 70 comprises any porous material capable of overlaying the pH sensitive material 34 without interfering with the optical variation of the pH sensing material 34 in response to contact with solutions of varying pH. Suitable and exemplary materials for the protective overcoat 70 include polysulfone (PSU), high-temperature stable polymers, and combinations thereof, or template-assist porous MeOx thin films. Additional overcoat layers include porous inorganic membrane layers such as zeolites and even hybrid organic-inorganic materials such as metalorganic frameworks. The addition of the protective overcoat provides mechanical protection of the fiber 20 and pH sensitive material 34 during deployment of the sensor 12 or sensor 102 into a testing environment.

In an embodiment, the whole portion of the sensor 12 or sensor 102 featuring a coreless fiber 36 is overlaid with the protective overcoat 70 such that the overcoat 70 overlays fiber 20 coated with pH sensitive material 34.

As described, supra, the invented sensor utilizes a coating of pH sensitive material 34 for point or distributed sensing of pH. In alternative embodiments, the sections featuring a coating of the pH sensitive material are underlaid, overlaid, or a combination thereof by layers of material that are suitable for detecting other parameters of the surrounding environment such as temperature, pressure, or the presence of specific chemical moieties. Similarly, the sensors described, supra, can feature segments coated with pH sensitive material 34 and segments coated in material suitable for detecting other parameters of the surrounding environment. In another embodiment, the inventors envision utilizing the pH sensitive material 34 to implement a combined fiber sensor for pH and temperature described in Fei Lu et al., “Distributed fiber optic chemical sensor with a temperature compensation mechanism,” Proc. SPIE 11500, ODS 2020: Industrial Optical Devices and Systems, 115000N (20 Aug. 2020), the entirety of which is incorporated by reference herein.

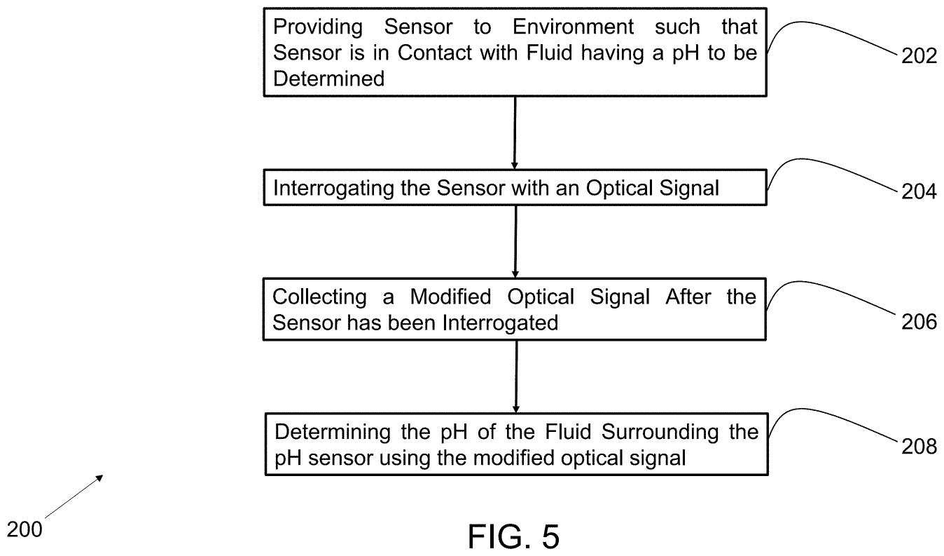

FIG. 5 provides a method of measuring pH using either of the invented pH sensors 10, 100 to determine the pH of a fluid surrounding and contacting said sensor. The method 200 begins by providing the pH sensor to an environment that contains or will contain a fluid having a pH 202. The method then continues with interrogating the sensor with an optical signal 204, collecting a modified optical signal after the sensor has been interrogated 206, and determining the pH of the fluid surrounding the pH sensor using the modified optical signal 208.

In the first step of the method 200 shown in FIG. 5, the pH sensor is deployed into an environment that contains or will contain a fluid having a pH to be measured 202. A salient feature of the invention is that the pH sensor is suitable for measuring pH in harsh environments. For example, the sensor is suitable for deployment in environments having temperatures of or more than 80° C. and pressures of or more than 3,000 psi. In a specific embodiment, the pH sensor can be deployed into a wellbore where temperatures are up to 300° C. and pressures up to 30,000 psi. The pH sensor is suitable for measuring pHs between approximately 2 and approximately 12.5.

As shown in FIG. 5 and described above, the invented method comprises collecting a modified optical signal after the sensor has been interrogated 206. In this step, the modified optical signal is light from the initial optical signal from the light source that is modified by interacting with the pH sensitive material 34 and either transmitted through the sensor to a downstream detector 16 or backscattered to the upstream OBR interrogator 104. The original optical signal will be modified varying amounts as the pH of the fluid contacting the pH sensitive material varies.

After collecting the modified optical signal 206, the instant invention is used to determine the pH of fluid contacting the pH sensitive material 34. To do this, the sensor system is tested with reference solutions having various pHs. With the collected modified optical signal in the testing of a fluid having an unknown pH, a user can compare the collected modified optical signal with test data in reference solutions to calculate the pH of the fluid contacting the pH sensitive material 34.

### Preparation of Sensor Fibers Using Sol Gel Methods

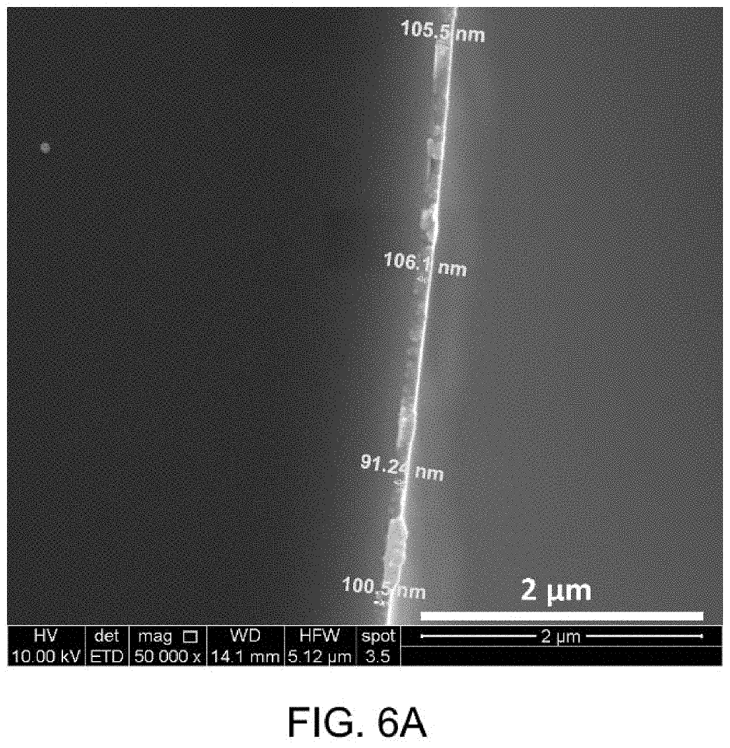

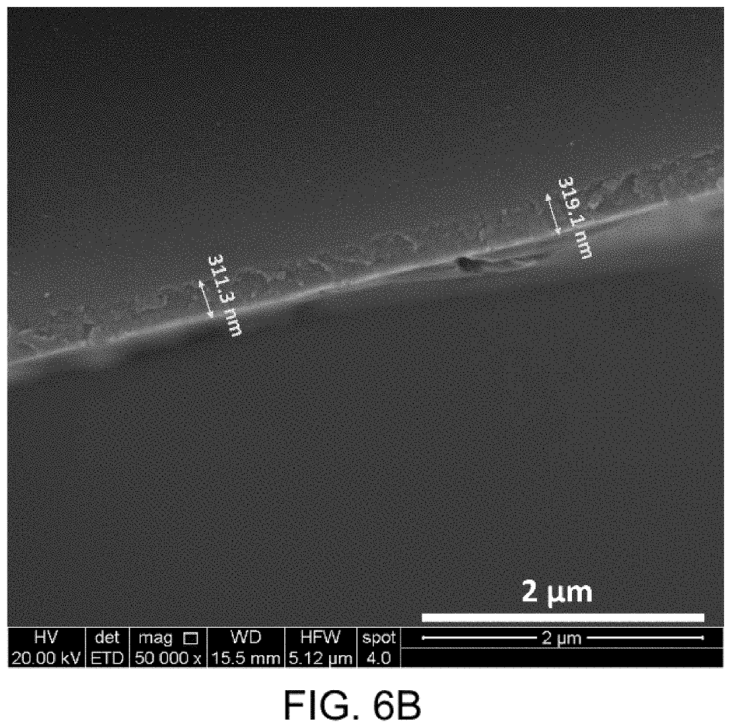

The fabrication of sol-gel TiO₂ and ZrO₂ coated pH sensors began with the preparation of a sol-gel solution. Table 2 provides detail on preparing the sol-gel solutions. The optical fiber substrate, multimode-coreless-multimode (MMF-coreless-MMF), was made by fusing MMFs to both ends of a coreless fiber with a fusion splicer. The polymer jacket on the coreless fiber was removed with a stripper after immersing the coreless fiber in acetone solution for 3-4 minutes. Subsequently, pH sensitive material was coated onto the coreless fiber using a dip-coating method by pulling the fiber through the sol-gel solution at a rate of approximately 1 cm per second. The dip coated fiber was then calcined at 500° C. for 2 hours in air using a tube furnace. As demonstrated in SEM images in FIGS. 6A and 6B, sol-gel TiO₂ and ZrO₂ were coated on optical fibers with a thickness of approximately 100 nm and approximately 300 nm respectively.

TABLE 2
Methods for Preparing the Sol-Gel solution used for Coating of MeOx
Based pH Sensing Materials

| | MeOx | |
|---|---|---|
| | TiO₂ | ZrO₂ |
| Sol-Gel | 7.5 ml isopropanol | 1.15 g ZrO(NO₃)₂ in 5.0 ml |
| Solution | 1.0 ml titanium | deionized water (DI) |
| | isopropoxide | 5.0 ml ethylene glycol |
| | 1.6 ml acetic acid, | Drops of 1.0 M NH₄OH till |
| | glacial | precipitation occurs |
| | | Drops of concentrated HNO₃ to |
| | | make sure precipitate is dissolved |
| Treatment | Room temperature | Room temperature |
| Condition | Rigorous stirring for | Rigorous stirring for 1 hr |
| | 2 hr | |

Additionally, metal oxides incorporated with localized surface-plasmon resonance (LSPR) nanoparticles, such as Au NPs, exhibit interesting optical properties and can be leveraged to increase the sensitivity and tune the sensing wavelengths. The fabrication of Au incorporated TiO₂ (Au—TiO₂) through the sol-gel method is similar to the pure sol-gel TiO₂, the only difference being the addition of 1.0 mL 80 mg/mL HAuCl₄ to the sol-gel solution for TiO₂ as shown in Table 2.

### Preparation of Sensor Fibers Using Atomic Layer Deposition

A compact ALD TiO₂ layer was deposited on a coreless optical fiber at 120° C. using a commercial ALD system available from Cambridge Nanotech Inc. Tetrakis(dimethylamido)titanium (TDMAT) and pure deionized (DI) water were the Ti source and oxidant, respectively. The substrate was held in a chamber with a base pressure of approximately 0.1 Torr during the sample heating. Once the temperature was increased to 120° C., in-line nitrogen gas flowed into the chamber as a carrier gas at the rate of 20 sccm and the process pressure of the chamber increased to 0.3 Torr. Then, TDMAT and water were sequentially injected to the chamber. During the deposition, temperature of the precursor (TDMAT) was maintained at 75° C. The reactions of high-purity TDMAT with DI water oxidant per one cycle are shown as Reactions (1)-(2) as follows:

Ti[N(CH₃)₂]₄+TiO₂—OH*→NH(CH₃)₂+TiO₂—O—Ti[N(CH₃)₂]*₃ Reaction (1)

TiO₂—O—Ti[N(CH₃)₂]*₃+2H₂O→TiO₂—TiO₂—OH*+3[NH(CH₃)₂] Reaction (2)

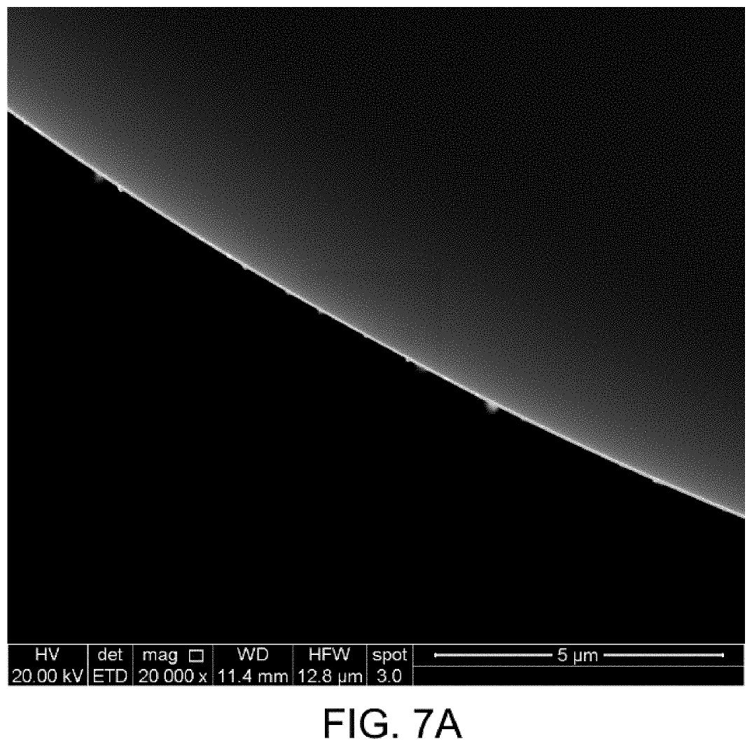

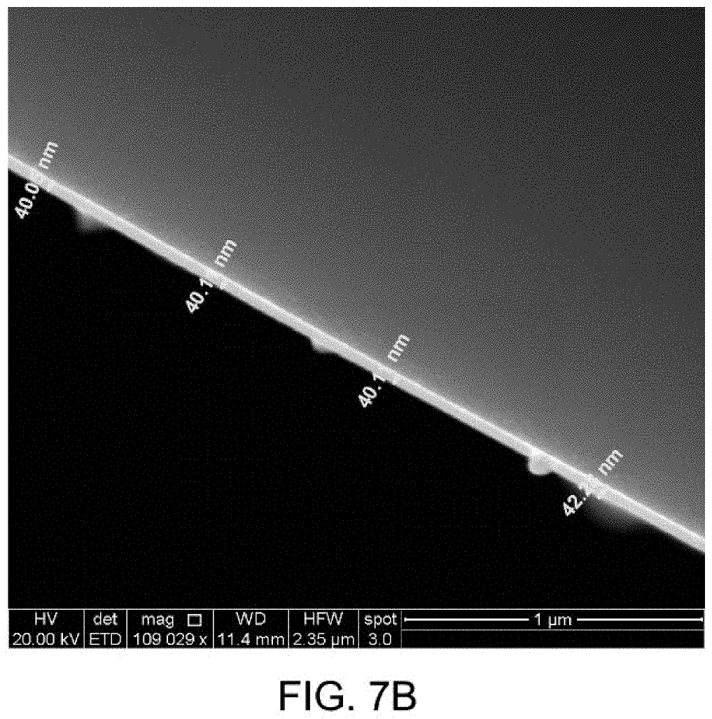

In each cycle, the pulse times of TDMAT and water were 0.15 s and 0.015 s, respectively, where the chamber was purged for 15 s between two pulses. The TiO₂ coating was made by 500 deposition cycles with the rate of approximately 0.1 nm deposited per cycle. As shown in SEM images in FIGS. 7A and 7B, ALD TiO₂ was coated on optical fiber with a thickness of approximately 40 nm.

### Preparation of Overcoated pH Fiber Optic Sensor

A fiber coated in TiO₂ using the above-described sol-gel preparation method was coated with polysulfone (PSU) overcoat. The PSU was prepared by mixing 0.4 g of PSU into 19.6 g of chloroform. The solution was then stirred at room temperature for 24 hours to generate a 2.0 wt % PSU in chloroform solution. To overcoat the fiber sensor with PSU, the TiO₂-coated fiber was pulled through the PSU in chloroform solution at a rate of approximately 1 cm per second. The fiber was then dried at 50° C. for 30 minutes.

### Examples Using Sol-Gel MeOx Coated Fiber Optic pH Sensors

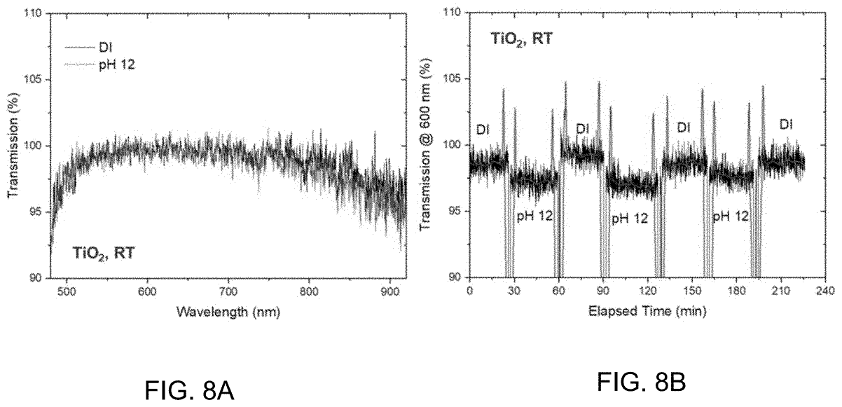

The pH sensing responses of sol-gel MeOx coated fiber optic pH sensors were measured by monitoring transmission spectral changes as the solution pH was varied. FIGS. 8A and 8B show the optical responses of a sol-gel TiO₂ coated fiber to solutions having different pH values at room temperature. FIGS. 8A and 8B further show that a broadband response to the solution pH, and that responses were reversible during the pH cycling, wherein cycling comprises contacting the sensor with DI water and then contacting the sensor with a solution having a pH of 12 or vice versa.

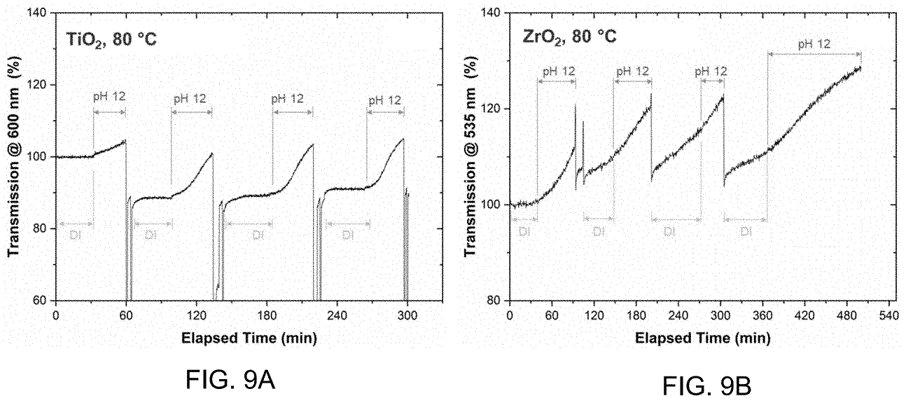

FIGS. 9A and 9B depict pH sensing results of sol-gel TiO₂ and ZrO₂ coatings at 80° C. during the pH cycling between DI water and pH 12. Both of them showed good potential for pH sensing with reversibility and higher stability compared to SiO₂ based coating at 80° C. at high pH. TiO₂ had a better performance than ZrO₂ regarding reversibility of DI water baselines at 80° C. The thickness and morphology of the MeOx sensing coatings can be designed and optimized to improve the pH sensing performance.

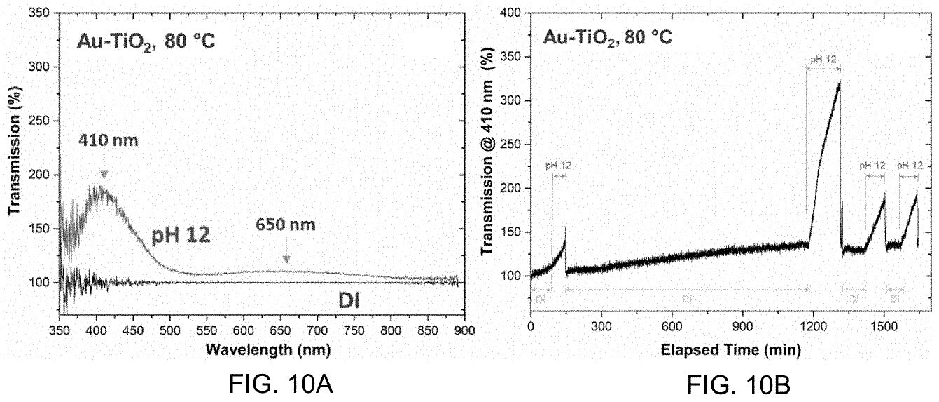

With incorporation of Au LSPR nanoparticles, Au—TiO₂ demonstrated pH sensing capability with two extinction peaks (410 nm and 650 nm wavelengths) from DI water to pH 12 at 80° C., as shown in FIG. 10A. FIG. 10B demonstrates pH sensing capability of Au—TiO₂ coating and its stability over at least 24 hours at 80° C. during dynamic pH cycling between DI water and pH 12. As Au LSPR is also sensitive to temperature, incorporation of Au nanoparticles can potentially enable multi-parameter sensing of pH and temperature, for example, through broadband wavelength interrogation techniques.

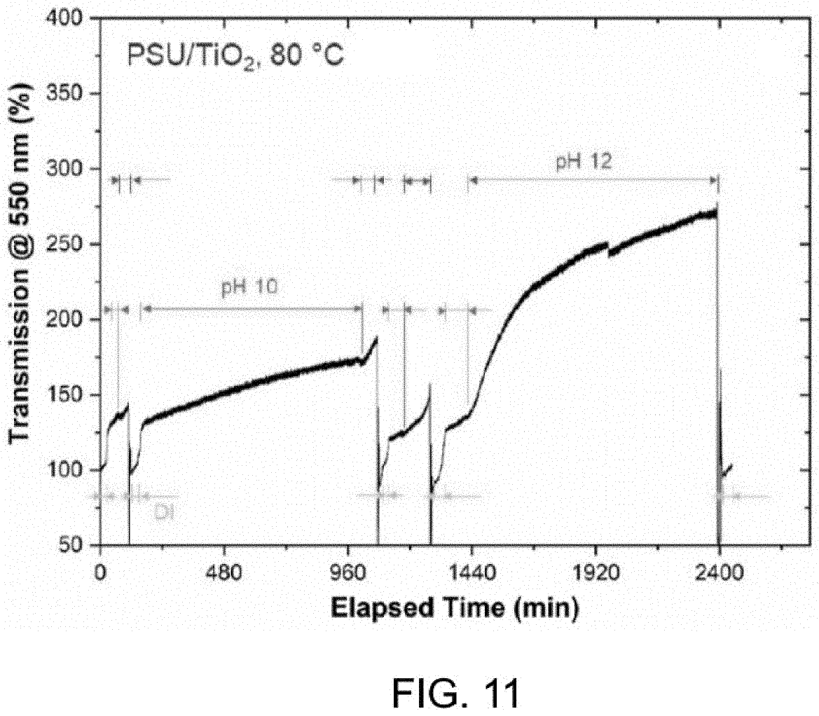

FIG. 11 shows pH sensing results for the fiber coated with TiO₂ and the PSU protective overcoat at 80° C. for more than 40 hours. As shown in FIG. 11, when the coated and overcoated fiber was exposed to increased pH, there was a resulting increase in transmission. In each cycle, the transmission reversed almost exactly back to the baseline when the coated and overcoated fiber was exposed to DI water.

### Examples Using ALD MeOx Coated Fiber Optic pH Sensors

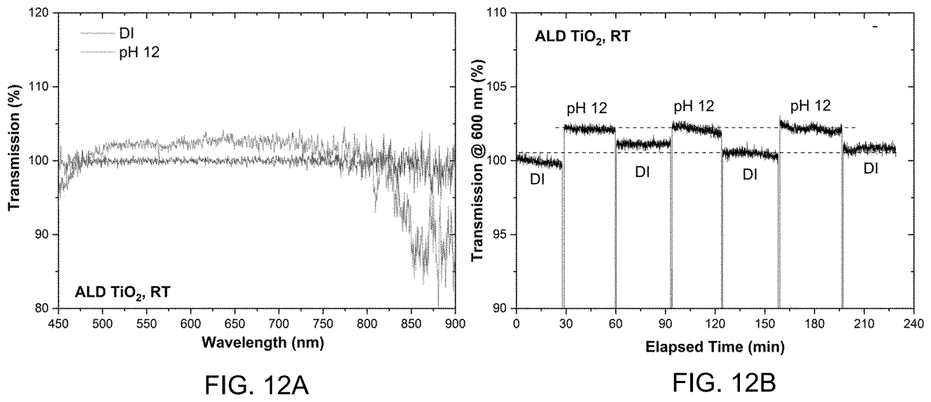

ALD TiO₂ coated optical fiber pH sensors have demonstrated improved stability, reversibility, and a quick response time. FIGS. 12A and 12B show optical responses of the ALD TiO₂ coated fiber to different pH values at room temperature. FIG. 12A shows a broadband response to the solution pH. In FIG. 12B, the ALD TiO₂ coated fiber optic pH sensor showed reversible sensitivity during pH cycling at room temperature. A transmission change of −2% at the wavelength of 600 nm was observed when the solution was switched from DI water to pH 12. Both ALD TiO₂ and sol-gel TiO₂ coated fiber optical sensors demonstrated good reversibility during pH cycling between DI water and pH 12 at room temperature. The ALD TiO₂ coating exhibited enhanced stability with a lower noise level relative to the sol-gel TiO₂ coating.

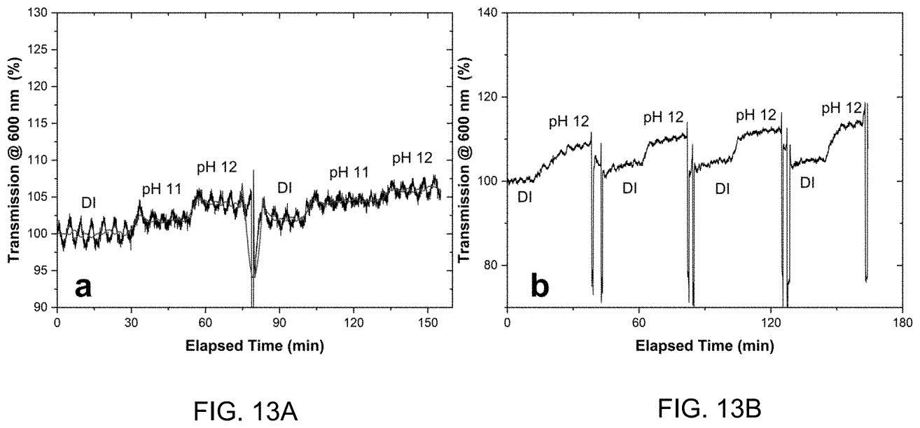

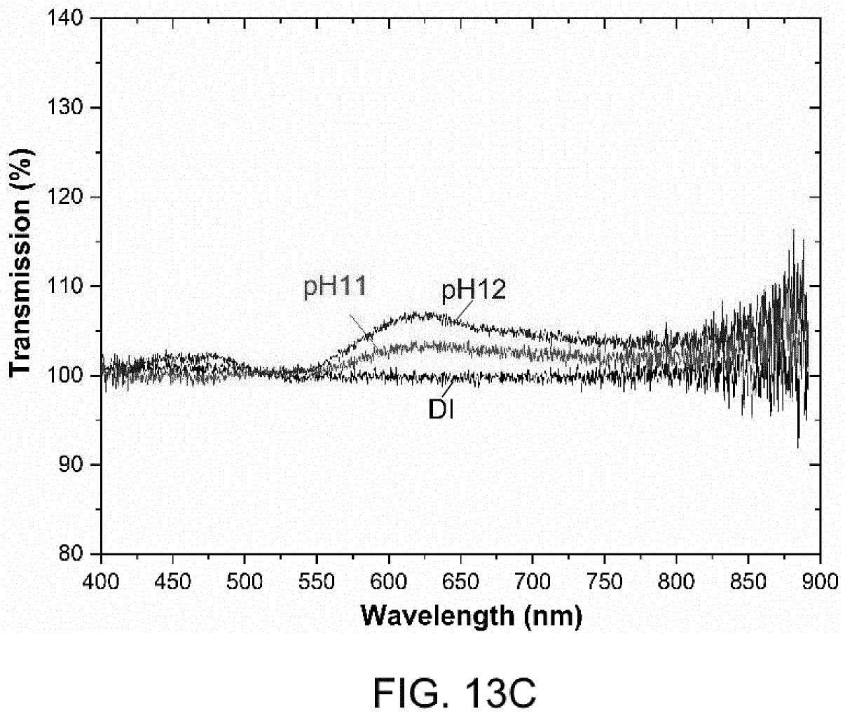

At 80° C., the transmission spectra of the ALD TiO₂ coated optical fiber sensor demonstrated a broad band pH sensing response in the wavelength range of 600 nm-850 nm as shown in FIG. 13C. As shown in FIGS. 13A and 13B for the selected wavelength of 600 nm, the ALD TiO₂ coated optical fiber sensor demonstrated improved stability and reversibility during pH sensing compared to the sol-gel TiO₂ sensor and a quicker response time of ALD TiO₂ coating (˜5 min at each pH point) compared to more than 30 minutes using the sol-gel TiO₂ coating as shown in FIG. 9A at 80° C.

### Distributed pH Sensing Example

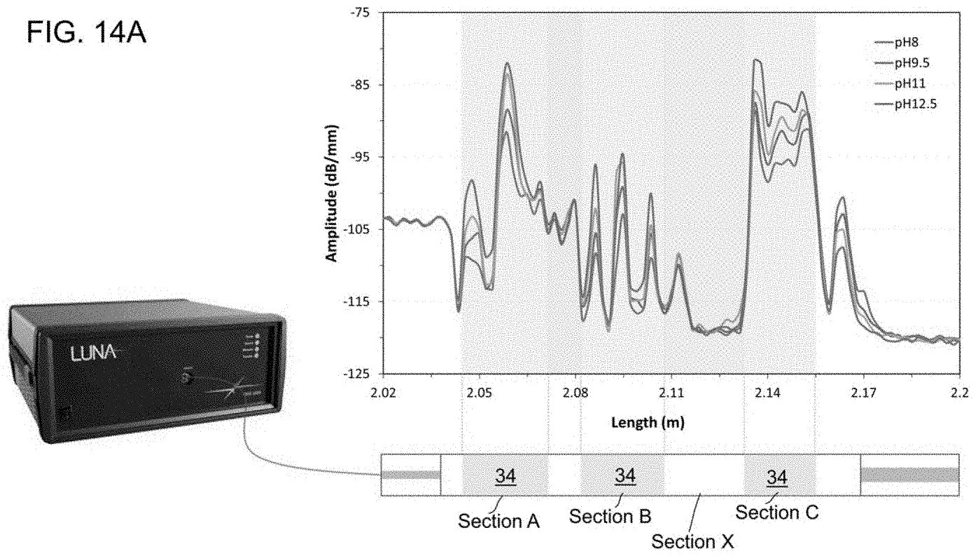

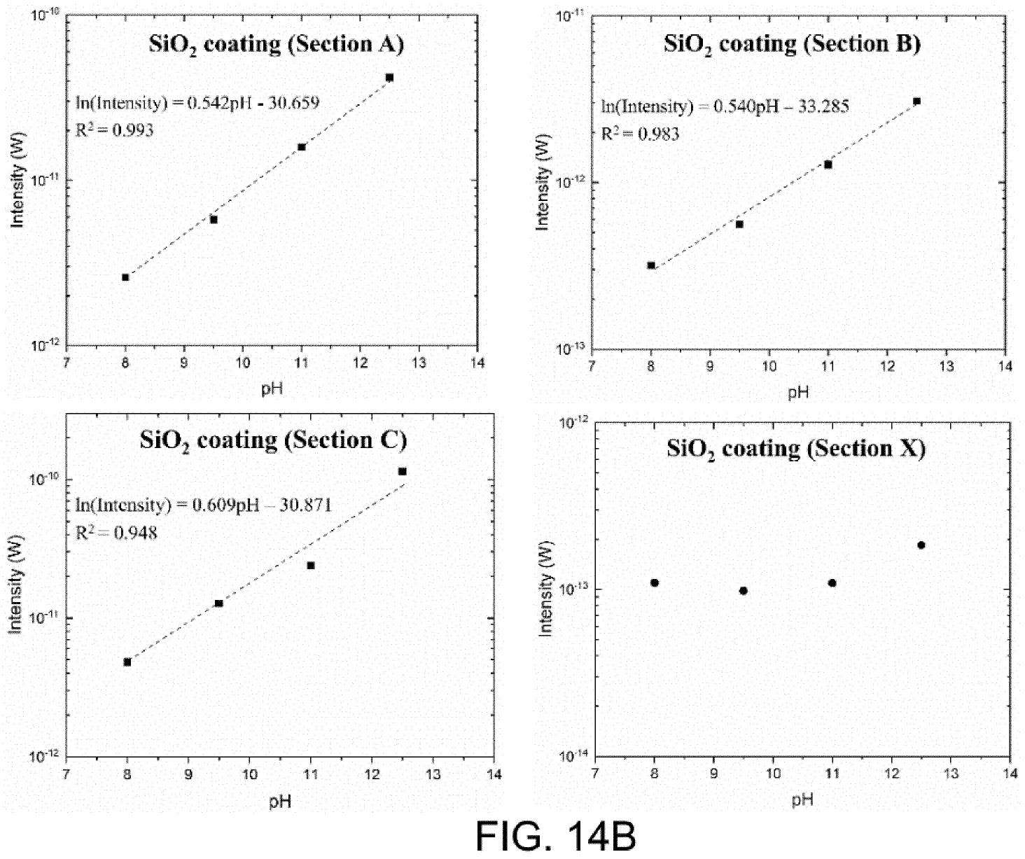

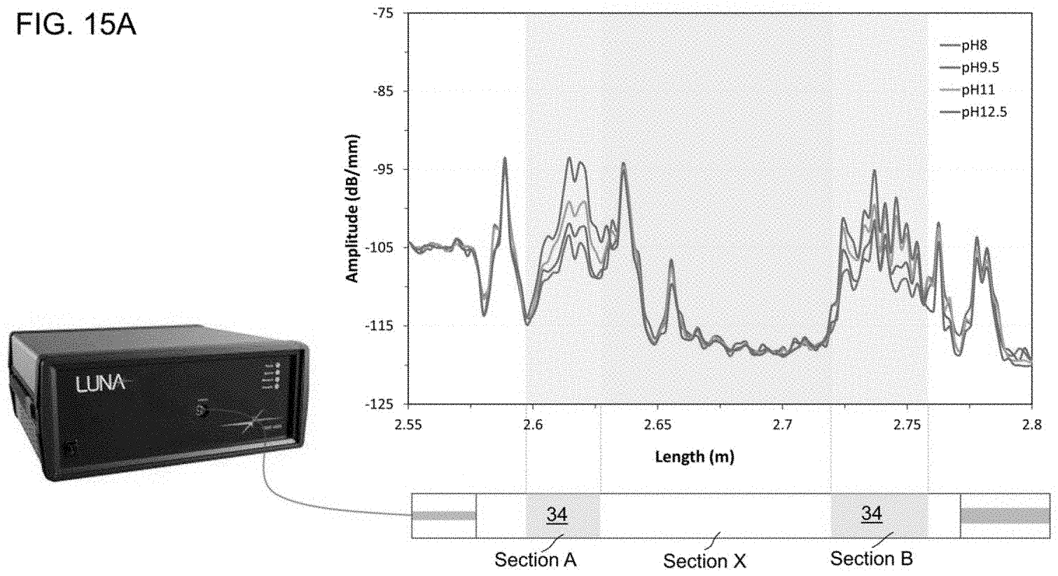

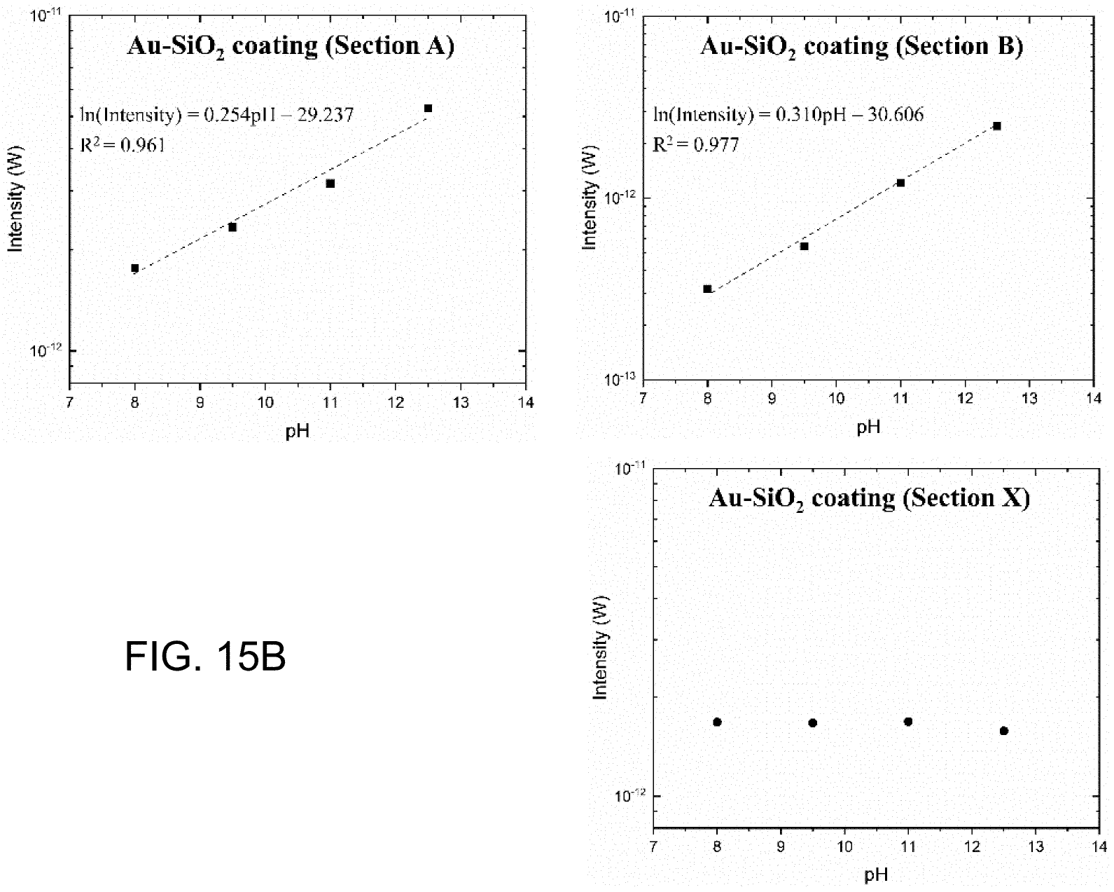

By connecting the MeOx coated fiber optic pH sensor to an OBR setup as shown in FIG. 2A and described above, distributed pH sensing can be achieved to obtain the spatially resolved pH profile with location information in real time. Successful distributed pH sensing has been demonstrated using SiO₂ and Au—SiO₂ coated fiber optical pH sensors as shown in FIGS. 14A, 14B, 15A, and 15B. OBR traces shown in FIGS. 14A and 15A show backscattered signals as a function of distance along the optical fiber sensor in contact with solutions of pH from 8 to 12.5. The light passed through a >2 m guide single mode fiber (SMF) and then reached the fiber optic sensing region. Almost no light loss was observed in the guiding SMF. Therefore, the pH sensor can be used for the applications towards deep wells using appropriate length of the guide SMF. At the pH sensitive sections, the amplitudes of the backscattered signals increased with higher pH due to enhanced local scattering resulting from the pH sensitive coating. The backscattered light intensity was exponentially increased as the solution pH increased as shown in FIGS. 14B and 15B. In contrast, regions which were not functionalized with pH sensitive coating did not show any significant or reversible intensity changes when pH varied.

An embodiment of the invention comprises deployment of embedded optical fiber sensors within wellbore cement for in-situ real-time monitoring of wellbore integrity. There are ˜1.7 million active oil and gas wells in the U.S., and, in 2018, the number of newly drilled wells was estimated at approximately 25,000. There are 3 million abandoned oil and gas wells across the United States. Almost all existing wells need cement for zonal isolation or plugging. Cement degradation leads to wellbore integrity failures, which can cause significant safety concerns with flammable gas/oil, economic loss, and environmental hazards (green-house gas leaks and underground water contamination). If the pH drops in cement (e.g. pH from 13 to 10) can be monitored in early stages before catastrophic failures occur, billions of dollars can be saved per year, and climate changes and water contamination can be mitigated.

Having described the basic concept of the embodiments, it will be apparent to those skilled in the art that the foregoing detailed disclosure is intended to be presented by way of example. Accordingly, these terms should be interpreted as indicating that insubstantial or inconsequential modifications or alterations and various improvements of the subject matter described and claimed are considered to be within the scope of the spirited embodiments as recited in the appended claims. Additionally, the recited order of the elements or sequences, or the use of numbers, letters or other designations therefor, is not intended to limit the claimed processes to any order except as may be specified. All ranges disclosed herein also encompass any and all possible sub-ranges and combinations of sub-ranges thereof. Any listed range is easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as up to, at least, greater than, less than, and the like refer to ranges which are subsequently broken down into sub-ranges as discussed above. As utilized herein, the terms “about,” “substantially,” “approximately,” and other similar terms are intended to have a broad meaning in conjunction with the common and accepted usage by those having ordinary skill in the art to which the subject matter of this disclosure pertains. As utilized herein, the term “approximately equal to” shall carry the meaning of being within 15, 10, 5, 4, 3, 2, or 1 percent of the subject measurement, item, unit, or concentration, with preference given to the percent variance. It should be understood by those of skill in the art who review this disclosure that these terms are intended to allow a description of certain features described and claimed without restricting the scope of these features to the exact numerical ranges provided. Accordingly, the embodiments are limited only by the following claims and equivalents thereto. All publications and patent documents cited in this application are incorporated by reference in their entirety for all purposes to the same extent as if each individual publication or patent document were so individually denoted.

All numeric values are herein assumed to be modified by the term “about”, whether or not explicitly indicated. The term “about” generally refers to a range of numbers that one of skill in the art would consider equivalent to the recited value (e.g., having the same function or result). In many instances, the terms “about” may include numbers that are rounded to the nearest significant figure.

The recitation of numerical ranges by endpoints includes all numbers within that range (e.g. 1 to 5 includes 1, 1.5, 2, 2.75, 3, 3.80, 4, and 5).

One skilled in the art will also readily recognize that where members are grouped together in a common manner, such as in a Markush group, the present invention encompasses not only the entire group listed as a whole, but each member of the group individually and all possible subgroups of the main group. Accordingly, for all purposes, the present invention encompasses not only the main group, but also the main group absent one or more of the group members. The present invention also envisages the explicit exclusion of one or more of any of the group members in the claimed invention.

What is claimed is:

1. A method to determine the pH of a fluid contacting a sensor comprising:
providing the sensor to an environment such that the sensor is in contact with the fluid, wherein the sensor comprises a fiber extending between a first end and a second end along a longitudinal axis, wherein the fiber further comprises a medial portion positioned between the first and second ends, wherein the sensor further comprises a pH sensitive coating on the medial portion of the fiber, and wherein the pH sensitive material comprises a metal oxide;
interrogating the sensor with an optical signal;
collecting a modified optical signal after the sensor has been interrogated; and
determining the pH of the fluid contacting the pH sensor using the modified optical signal.

2. The method of claim 1 wherein the metal oxide is selected from the group consisting of: SiO₂, TiO₂, ZrO₂, Ta₂O₅, Al₂O₃, and combinations thereof.

3. The method claim 2 wherein the pH sensitive material further comprises Au nanoparticles.

4. The method of claim 1 wherein the modified optical signal is collected downstream from the sensor by a simple optical detector.

5. The method of claim 1 wherein the modified optical signal is backscattering from the sensor that is collected using an optical backscatter reflectometry interrogator.

6. The method of claim 1 wherein the environment comprises temperatures more than 80° C. and pressures of or more than 3,000 psi.

7. The method of claim 1 wherein the pH of the fluid is between approximately 2 and approximately 12.5.

8. The method of claim 1 wherein the medial portion of the fiber features a plurality of spaced apart portions of fiber that are coated with the pH sensitive material.

9. The method of claim 8 further comprising using the modified optical signal to determine the pH of the fluid contacting each of the plurality of spaced apart portions that are coated with the pH sensitive material.

10. The method of claim 1 wherein the pH sensitive material overlays a porous inorganic oxide selected from the group consisting of SiO₂, TiO₂, Al₂O₃, ZrO₂, Ta₂O₅, and combinations thereof.

11. The method of claim 1 wherein the pH sensitive material is coated with a protective overcoat.

12. The method of claim 1 wherein the pH sensitive material is deposited on the fiber using a sol-gel technique.

13. The method of claim 1 wherein the pH sensitive material is deposited on the fiber using atomic layer deposition.

14. The method of claim 1 wherein the coating of pH sensitive material has a thickness between approximately 10 nm and approximately 1 μm.

15. A pH sensor comprising:
a fiber extending between a first end and a second end along a longitudinal axis, wherein the fiber further comprises a medial portion positioned between the first and second ends; and
a pH sensitive coating on the medial portion of the fiber,
wherein the pH sensitive material comprises a metal oxide.

16. The sensor of claim 15 wherein the metal oxide is selected from the group consisting of: SiO₂, TiO₂, Ta₂O₅, Al₂O₃, and combinations thereof.

17. The sensor of claim 15 wherein the medial portion of the fiber features a plurality of spaced apart portions that are coated with the pH sensitive material.

18. The sensor of claim 15 wherein the medial portion of the fiber comprises a coreless fiber.
